(19) United States
(12) Patent Application Publication
(10) Pub. No.: US 2007/0002556 A1
(43) Pub. Date: Jan. 4, 2007

(54) Illuminated headwear

(76) Inventor: Tsz-Ming Lou, Kowloon (CN)

Correspondence Address: ALIX YALE & RISTAS LLP, 750 MAIN STREET, SUITE 1400, HARTFORD, CT, 06103, US

(21) Appl. No.: 11/170,669

(22) Filed: Jun. 29, 2005

(51) Int. Cl. F21V 21/084

(52) U.S. Cl. 362/106; 362/105; 362/103

(57) ABSTRACT

Headwear includes a light-transmissive visor, a power source, and a light emitter powered by the power source and directed at the visor.

### BACKGROUND OF THE INVENTION

The present invention relates to headwear. More particularly, although not exclusively, the invention relates to headwear incorporating an illuminated visor. Promoters, fun-seekers, party-goers and children might like to don headwear incorporating an illuminated visor.

### OBJECTS OF THE INVENTION

It is an object of the present invention to provide interesting and entertaining headwear incorporating an illuminated visor.

### DISCLOSURE OF THE INVENTION

There is disclosed herein headwear, comprising:
a light-transmissive visor,
a power source, and
a light emitter powered by the power source and directed at the visor.

Preferably, the visor has printed matter thereon for illumination by the light emitter.

Preferably, the light source is directed at a bottom surface of the visor and the illuminated printed matter is visible at a top surface of the visor.

Preferably, the headwear comprises a plurality of said light emitters in an array directed at the visor.

Preferably, the headwear comprises a headband to which the power source and light emitters are mounted, and wherein the visor comprises clips for the detachment from the headband enabling removal and replacement of the visor.

### BRIEF DESCRIPTION OF THE DRAWINGS

A preferred form of the present invention will now be described by way of example with reference to the accompanying drawings, wherein:

FIG. 1 is a schematic perspective illustration of headwear incorporating an illuminated visor, and

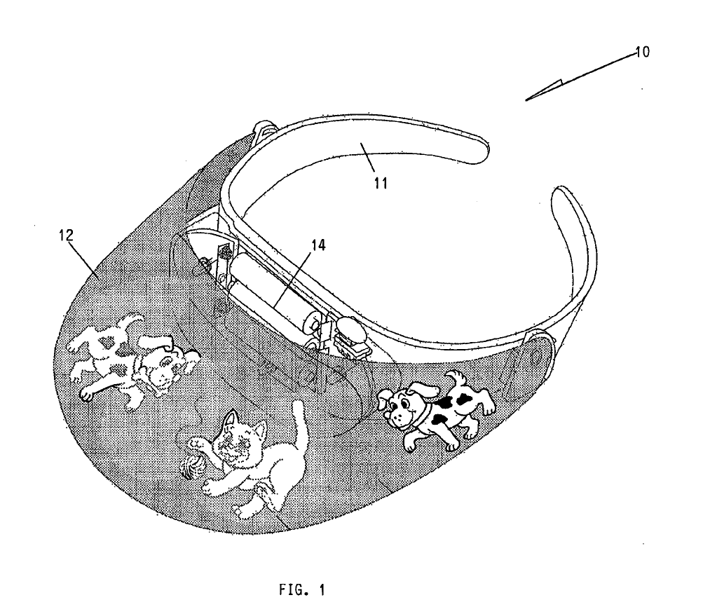

FIG. 2 is a schematic outside in exploded perspective illustration of the headwear of FIG. 1 excluding the visor.

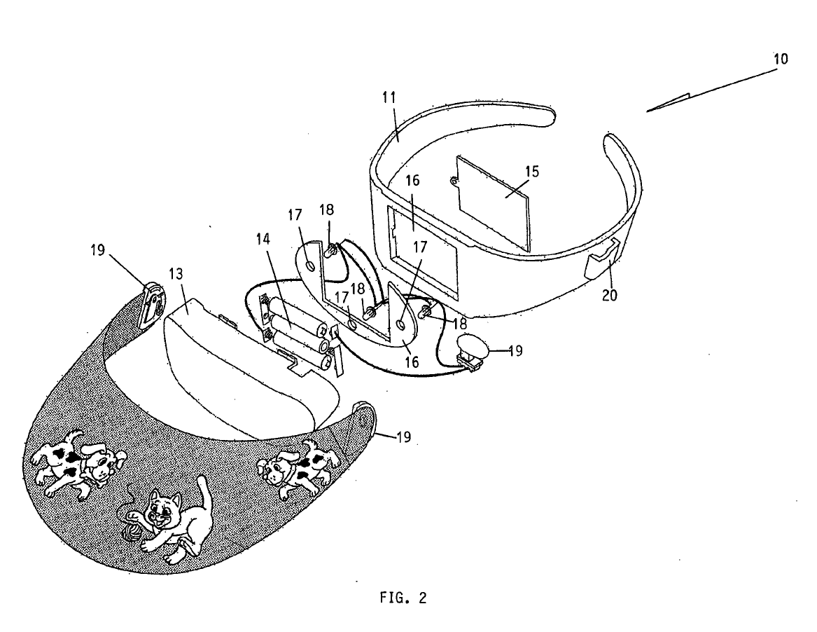

### DESCRIPTION OF THE PREFERRED EMBODIMENT

In the accompanying drawings there is depicted schematically an item of headwear in the form of a cap 10 including a headband 11 and the visor 12. At the front of the headband 11, there is provided a battery compartment 13 housing a plurality of batteries 14 (typically size AAA batteries). A cover plate 15 covers an opening 16 in the headband behind the compartment 13 through which the batteries 14 can be inserted and removed.

The compartment 13 is typically made of light-transmissive plastics material.

An LED mounting plate 16 surrounds the batteries 14 within the compartment 13 and comprises a number of apertures 17 for each receiving an LED 18. The LEDs 18 are connected via wires and a switch 19 to the batteries 14.

The visor 12 is also made of light-transmissive plastics material and comprises a pair of opposed clamps 19 each adapted to cooperate with clamping lugs 20 at opposite sides of the headband 11 to secure the visor in place enabling pivotal movement up-and-down and detachment/replacement as desired. The visor 12 can have printed matter thereon—say in the form of a logo, advertising or anything else.

The LEDs shine through the light-transmissive compartment 13 onto the under-side of the visor and then through the visor to illuminate the printed matter. The LEDs are typically broad-spectrum white light-emitting diodes.

It should be appreciated that modifications and alterations obvious to those skilled in the art are not to be considered as beyond the scope of the present invention. For example, circuitry might be provided to cause the LEDs to flash randomly or in a chasing sequence, and different coloured LEDs might be provided.

1. Headwear, comprising:
a light-transmissive visor,
a power source, and
a light emitter powered by the power source and directed at the visor.

2. The headwear of claim 1, wherein the visor has printed matter thereon for illumination by the light emitter.

3. The headwear of claim 2, wherein the light source is directed at a bottom surface of the visor and the illuminated printed matter is visible at a top surface of the visor.

4. The headwear of claim 3, comprising a plurality of said light emitters in an array directed at the visor.

5. The headwear of claim 4, comprising a headband to which the power source and light emitters are mounted, and wherein the visor comprises clips for the detachment from the headband enabling removal and replacement of the visor.
